(19) United States
(12) Patent Application Publication
(10) Pub. No.: US 2010/0214538 A1
(43) Pub. Date: Aug. 26, 2010

(54) OPTICAL UNIT AND PROJECTION DISPLAY DEVICE

(76) Inventors: Hiroaki Fukunaga, Tokyo (JP); Takayuki Okada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/733,659

(22) PCT Filed: Oct. 9, 2008
(86) PCT No.: PCT/JP2008/068368

§ 371 Date: Mar. 12, 2010

(30) Foreign Application Priority Data
Oct. 10, 2007 (JP) 2007-264442

(51) Int. Cl. G02B 7/02; G02B 27/12; G02B 5/30; G03B 21/14; B29D 11/00

(52) U.S. Cl. 353/38; 359/622; 359/485; 264/1.1

(57) ABSTRACT

An optical unit (1) is disclosed that is equipped with a pair of integrator lenses (11 and 14) secured to a holder (12), the optical unit (1) including a first frame-shaped metal plate (10) secured to the holder (12) in a state in which a portion of the principal surface contacts with a first surface (A) of the holder (12) and a second frame-shaped metal plate (15) secured to the holder (12) in a state in which a portion of the principal surface contacts with a second surface (B) of the holder (12). One lens array (11) is positioned with respect to the optical axis direction by securing the lens formation surface to an area which is a part of the surface of the principal surface of frame-shaped metal plate (10) and which does not contact with the first surface (A) of the holder (12). The other lens array (14) is positioned with respect to the optical axis direction by securing the lens formation surface to an area which is a part of the principal surface of frame-shaped metal plate (15) and which does not contact with the second surface (B) of the holder (12).

### TECHNICAL FIELD

The present invention relates to an optical system for irradiating light emitted from a light source onto an image-forming element of a projection display device.

### BACKGROUND ART

A projection display device modulates light (illumination light) emitted from a light source based on a video signal and projects the modulated light onto a screen. The modulation of the illumination light employs image-forming elements such as a liquid crystal panel or DMD (Digital Micro-Mirror Devices). Here, the luminance distribution of the illumination light must be made uniform to obtain a high-quality image. Still further, when the image-forming element is a liquid crystal panel, the polarization direction of the illumination light must be unified to obtain images of higher quality. Here, the illumination optical system that guides the illumination light to the image-forming element (liquid crystal panel) includes an optical unit having the function of making the luminance distribution of the illumination light uniform and the function of unifying the polarization directions. An illumination optical system that is provided in a typical projection display device is next described with reference to FIG. 1.

As shown in FIG. 1, illumination light emitted from light source 110 is reflected at reflector 120 and passes through first integrator lens 112, second integrator lens 113, polarization conversion element 115, and field lens 165. First integrator lens 112 and second integrator lens 113 are lens arrays (fly-eye lens) having a plurality of micro-lenses arranged in matrix form. First integrator lens 112 splits the illumination light (luminous flux) into a plurality of luminous fluxes. Second integrator lens 113 together with field lens 165 causes the image of each micro-lens of first integrator lens 112 to form an image on a liquid crystal panel. In addition, polarization conversion element 115 converts illumination light that is irradiated into field lens 165 to a predetermined polarized light (assumed in this case to be S-polarized light). The illumination light that has undergone polarization conversion (S-polarized light) is irradiated into dichroic mirror 161. Dichroic mirror 161 reflects the red light (R) that is included in the irradiated illumination light. In other words, the red light is separated from the illumination light. The illumination light that has passed through dichroic mirror 161 is irradiated into dichroic mirror 162. Dichroic mirror 162 reflects the green light (G) included in the irradiated illumination light. In other words, the illumination light is separated into green light and blue light (B).

The red light that was separated by dichroic mirror 161 is irradiated into liquid crystal panel 191R by way of reflection mirror 171 and condenser lens 189R. The green light that was separated by dichroic mirror 162 is irradiated into liquid crystal panel 191G by way of condenser lens 189G. The blue light that has passed through dichroic mirror 162 is irradiated into liquid crystal panel 191B by way of a relay optical system made up from relay lenses 181 and 182 and reflection mirrors 172 and 173.

The colored light irradiated into each of liquid crystal panels 191R, 191G, and 191B is modulated by the respective liquid crystal panels. The modulated light is irradiated into cross-dichroic prism 193 and synthesized. The synthesized light is then projected toward projection surface (not shown) by projection lens 194.

Here, the uniformity of the coloring and brightness of the image that is projected on the projection surface depends on the uniformity of the luminance distribution and polarized state of the illumination light as well as the incident position and incident angle to the liquid crystal panel. The polarized state of the illumination light is greatly dependent on the positional accuracy of the optical elements that make up the illumination optical system. A number of techniques have been proposed for improving the positional accuracy of the optical elements that make up the illumination optical system.

JP-A-2005-352349 discloses a holder provided with a reference surface for positioning the first integrator lens and second integrator lens with respect to triaxial directions. This holder has a first face on which the first integrator lens is secured and a second face on which the second integrator lens is secured. A reference surface for positioning the first integrator lens with respect to the direction of the optical axis is formed on the first face, and a reference surface for positioning the second integrator lens with respect to the direction of the optical axis is formed on the second face.

When the lens array is fabricated by injection molding using a die, the accuracy of the lens formation surface is given priority over the accuracy of other surfaces. As a result, these lens formation surfaces are preferably taken as reference surfaces to position the first integrator lens and second integrator lens with high accuracy. JP-A-2005-352349 therefore discloses placing the lens formation surface of the first integrator lens in contact with a reference surface provided on the first surface of a base frame to implement positioning of the direction of the optical axis. The document further discloses placing the lens formation surface of the second integrator lens in contact with a reference surface provided on the second surface of the base frame to implement positioning of the direction of the optical axis.

### DISCLOSURE OF THE INVENTION

### Problem to be Solved by the Invention

According to the technology disclosed in JP-A-2005-352349, when the lens formation surfaces of the two integrator lenses are opposed with the holder interposed, these two integrator lenses can be positioned with high accuracy.

However, as described hereinabove, in the lens array, the accuracy of the lens formation surfaces is higher than the accuracy of other surfaces. In other words, the accuracy of the surface on the opposite side of the lens formation surface (hereinbelow referred to as “rear surface”) is lower than that of the lens formation surface. Accordingly, when the rear surface of the integrator lens confronts the holder, the positioning accuracy of the integrator lens is degraded.

It is an object of the present invention to realize an optical unit in which, even when the surface having the greatest accuracy of the lens array does not directly contact with the holder, the lens array is positioned with high accuracy.

### Means for Solving the Problem

The optical unit of the present invention is an optical unit provided with a first lens array and a second lens array secured to a holder, wherein light emitted from the first lens array passes through the holder and is incident to the second lens array. The optical unit of the present invention includes a first frame-shaped metal plate that is secured to the holder in a state in which a portion of the principal surface contacts with the first surface of the holder. The first lens array is positioned with respect to the direction of the optical axis by securing the lens formation surface to, of the principal surface of the first frame-shaped metal plate, an area that does not contact with the first surface of the holder.

### Effect of the Invention

An optical unit is realized in which a lens array, concerning which the lens formation area does not contact with the holder, is positioned with high accuracy.

The above and other objects, characteristics, and advantages of the present invention will become clear by referring to the following description and accompanying drawings that show examples of the present invention.

### BRIEF DESCRIPTION OF THE DRAWINGS

FIG. 1 is a schematic view of the basic construction of a projection display device;

FIG. 2 is an outer perspective view showing an example of an embodiment of the optical unit shown in FIG. 2;

FIG. 3 is six-plane view of the optical unit of the present invention;

FIG. 4 is an exploded perspective view of the optical unit shown in FIG. 2;

FIG. 5 is a partially abbreviated exploded perspective view of the optical unit shown in FIG. 2 as seen from the light-incident side;

FIG. 6A is a plan view of the optical unit shown in FIG. 2 as seen from the light-incident side, and is a plan view of the unit before the first frame-shaped metal plate is secured to the holder;

FIG. 6B is a plan view of the optical unit shown in FIG. 2 as seen from the light-incident side, and is a plan view of the optical unit after the first frame-shaped metal plate is secured to the holder;

FIG. 7 is a partially abbreviated exploded perspective view of the optical unit shown in FIG. 2 as seen from the light-emission side;

FIG. 8 is a partially abbreviated exploded perspective view of the optical unit shown in FIG. 2 as seen from the light-emission side;

FIG. 9 is a plan view of the optical unit shown in FIG. 2 as seen from the light-emission side;

FIG. 10A is a perspective view of the holder in which the first and second integrator lenses are secured as seen from the light-emission side;

FIG. 10B is a perspective view of the holder in which the first and second integrator lenses are secured as seen from the light-emission side;

FIG. 11 is a partially abbreviated exploded perspective view of the optical unit shown in FIG. 2 as seen from the light-emission side; and

FIG. 12 is a perspective view showing the state in which the optical unit shown in FIG. 2 is incorporated in the optical engine of a projection display device.

### BEST MODE FOR CARRYING OUT THE INVENTION

### First Embodiment

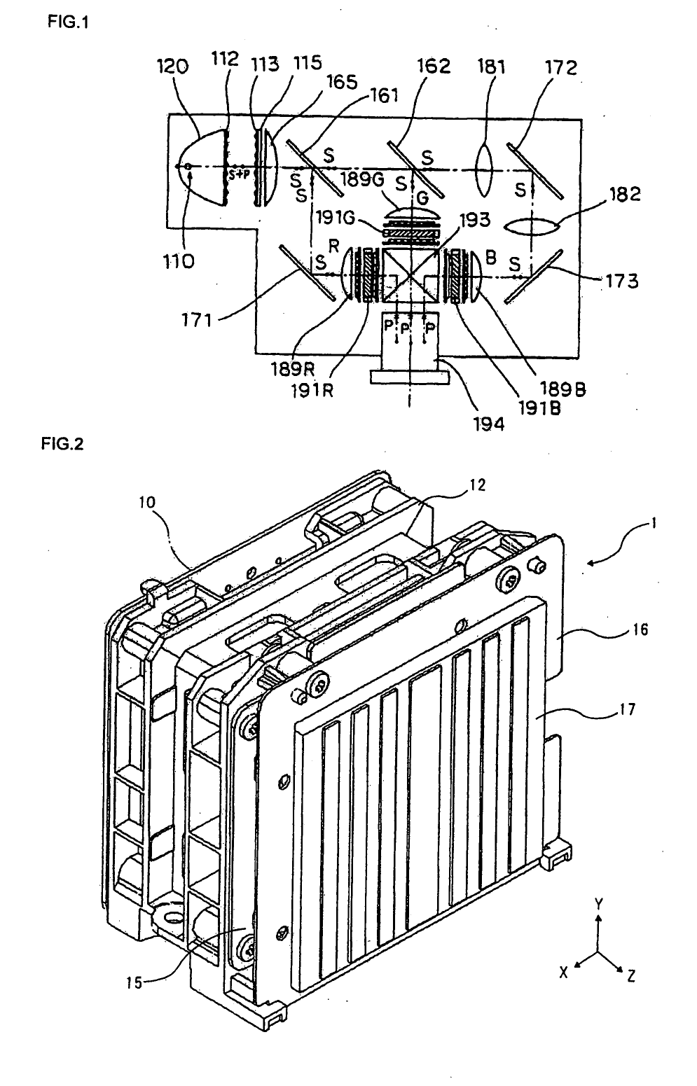

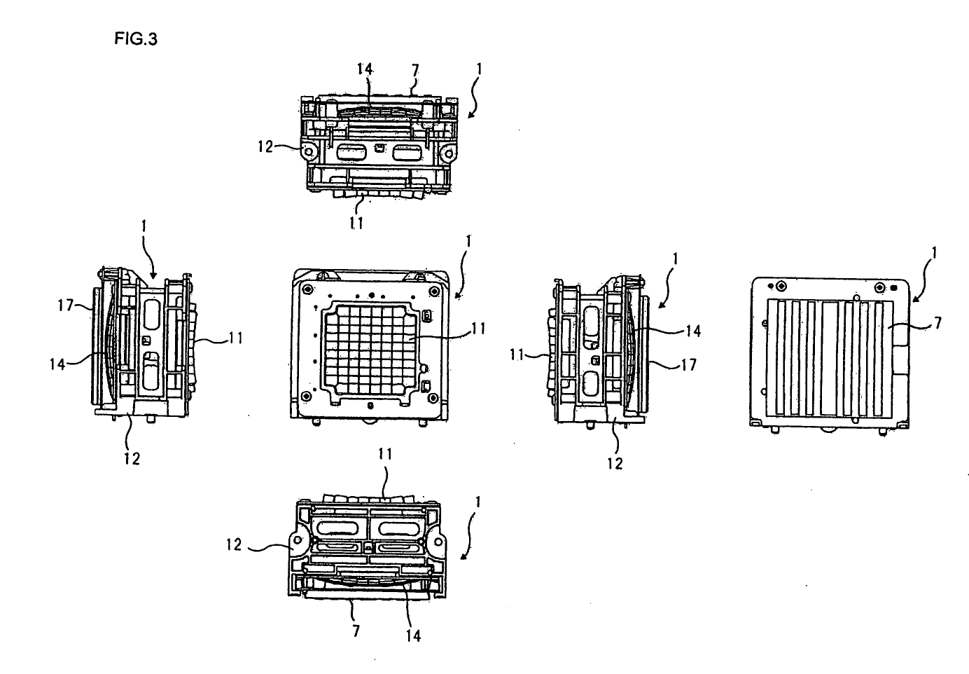

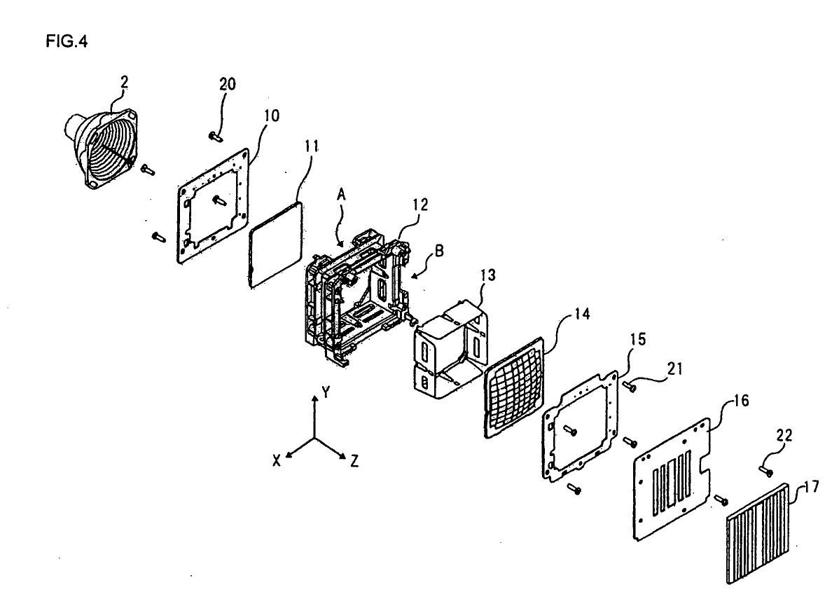

Examples of embodiments of the optical unit of the present invention are next described in detail with reference to the accompanying figures. FIG. 2 is a perspective view of optical unit 1 according to the present embodiment, FIG. 3 is a six-plane view of the optical unit, and FIG. 4 is an exploded perspective view of optical unit 1. Optical unit 1 according to the present embodiment makes up the illumination optical system of a projection display device. Optical unit 1 has the function of making the luminance distribution of light emitted from light source 2 (FIG. 4) uniform and irradiating the image-forming elements of the projection display device.

The constituent elements of optical unit 1 will first be summarized while referring chiefly to FIG. 4. Optical unit 1 includes: first frame-shaped metal plate 10 arranged along the optical axis of light emitted from light source 2, first integrator lens 11, integrator holder (hereinbelow referred to as “holder 12”), light-shield part 13, second integrator lens 14, second frame-shaped metal plate 15, light-shield plate 16, and polarization conversion element 17. Of these constituent elements, constituent elements other than holder 12 are directly or indirectly secured and unified with holder 12.

First integrator lens 11 and second integrator lens 14 are lens arrays (fly-eye lenses) having a plurality of lenses arranged in a lattice form (the plurality of lenses sometimes being collectively referred to as a “lens group”). In the following explanation, the surfaces on which the lens groups are formed in first integrator lens 11 and second integrator lens 14 are referred to as “lens formation surfaces” and the sides opposite the lens formation surfaces are referred to as “rear surfaces.”

First integrator lens 11 is positioned with respect to three orthogonal axial directions (X, Y, and Z axial directions) and secured onto first surface A of holder 12. Second integrator lens 14, light-shield plate 16, and polarization conversion element 17 are positioned with respect to the same triaxial directions and secured onto second surface B on the side opposite first surface A of holder 12. In addition, light-shield part 13 is positioned with respect to the same triaxial directions and secured inside holder 12. Here, as clearly shown in, for example, FIGS. 2 and 3, the Z-axis is parallel with the optical axis, and the X-axis and Y-axis are orthogonal to Z-axis. Still further, the X-axis and Y-axis are mutually orthogonal. In the following explanation, the Z-axis direction is sometimes referred to as the “optical axis direction,” the X-axis direction is sometimes referred to as the “horizontal direction,” and the Y-axis direction is sometimes referred to as the “vertical direction.”

In addition to the construction of holder 12, the construction by which each of the above-described constituent elements is secured to holder 12 is next described in detail. Holder 12 is a square frame-shaped part composed of an engineering plastic resin material such as polyphenylene sulfide (PPS), polycarbonate, or polyether imide (PEI). An injection molding method is used in the formation of holder 12. The injection molding method is a fabrication method in which a resin material that has been melted by a high-temperature cylinder is caused to flow into a die to form a molded article. The die includes a set of a fixed die and a movable die, the resin material being caused to flow into a cavity formed between these dies. In a molded article that is formed by the injection molding method, parts that are formed by the inner surfaces that are inner surfaces (forming surfaces) of the movable die and fixed die that are orthogonal to the direction of movement of the movable die have the highest accuracy. First surface A and second surface B of holder 12 in the present embodiment are formed by forming surfaces that are orthogonal to the direction of movement of the movable die. Accordingly, first surface A and second surface B of holder 12 have higher dimensional accuracy and surface accuracy than other surfaces. First surface A of holder 12 is reference surface (reference surface Z1) for positioning first integrator lens 11 with respect to the optical axis direction. Second surface B of holder 12 is the reference surface (reference surface Z2) for positioning second integrator lens 14 with respect to the optical axis direction.

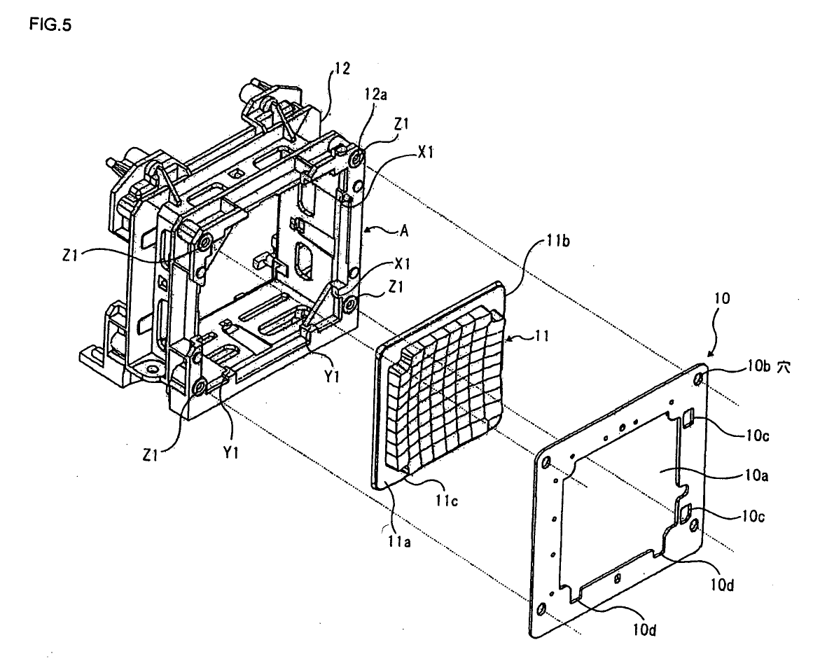

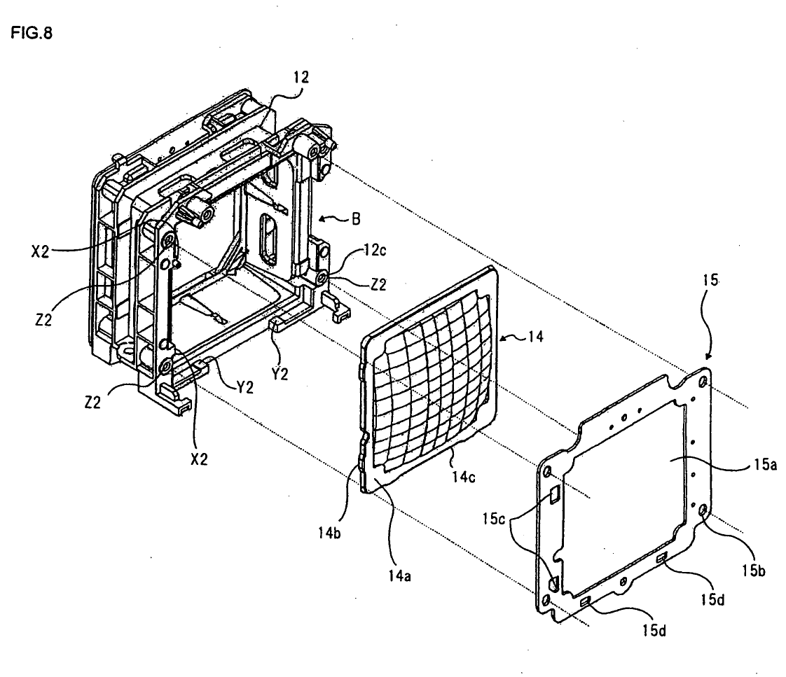

In addition, reference surfaces X1 and Y1 for positioning first integrator lens 11 with respect to the horizontal direction and vertical direction are provided on the end of the light-incident side, which is the inner side of holder 12 (FIG. 5). Reference surfaces X2 and Y2 for positioning second integrator lens 14 with respect to the horizontal direction and vertical direction are further provided on the end of light-emission side that is the inner surface of holder 12 (FIG. 8).

The construction for securing each constituent element to holder 12 is next described in detail. First, the construction for securing first integrator lens 11 will be described while referring chiefly to FIG. 5. FIG. 5 is an exploded perspective view of optical unit 1 as seen from the light-incident side. However, a portion of the constituent elements is omitted from the view.

First integrator lens 11 is secured to first frame-shaped metal plate 10. First frame-shaped metal plate 10 to which first integrator lens 11 is secured is secured to first surface A of holder 12 by screws 20 (FIG. 4). More specifically, first frame-shaped metal plate 10 is formed in a square frame shape in which opening 10a is provided in the center. The lens group of first integrator lens 11 is fitted into the inner side of opening 10a of first frame-shaped metal plate 10, and lens formation surface 11a of the periphery of the lens group is bonded to first frame-shaped metal plate 10. In the following explanation, of the two principal surfaces of first frame-shaped metal plate 10, the surface to which lens formation surface 11a of first integrator lens 11 is bonded is referred to as the “rear surface,” and the surface opposite the rear surface is referred to as the “obverse surface.” In other words, lens formation surface 11a of first integrator lens 11 and the rear surface of first frame-shaped metal plate 10 are bonded in direct contact. Here, as previously stated, the dimensional accuracy and surface accuracy of lens formation surface 11a of first integrator lens 11 are higher than the rear surface. In other words, first integrator lens 11 is positioned with respect to first frame-shaped metal plate 10 and is secured to first frame-shaped metal plate 10 with relatively accurate lens formation surface 11a as the reference surface.

Still further, first frame-shaped metal plate 10 is larger than first integrator lens 11, and the peripheral portion of first frame-shaped metal plate 10 protrudes outside from lens formation surface 11a of first integrator 11. In other words, a region exists on the rear surface of first frame-shaped metal plate 10 that does not overlap with lens formation surface 11a of first integrator 11. A plurality of holes 10b are formed on the peripheral portion of first frame-shaped metal plate 10. First frame-shaped metal plate 10 is secured to holder 12 by means of screws 20 (FIG. 4) that are inserted into each of holes 10b. Here, screw holes 12a into which screws 20 are screwed are formed on first surface A of holder 12, and the rear surface of first frame-shaped metal plate 10 directly contacts with the surface of the peripheries of screw holes 12a. In other words, of the first surface A of holder 12, the areas around screw-holes 12a are used as reference surface Z1 for positioning first frame-shaped metal plate 10 with respect to the optical axis direction. This means that first integrator lens 11 that is secured to first frame-shaped metal plate 10 is positioned with respect to the optical axis direction with reference surface Z1 as a reference. Referring to FIG. 5, reference surface Z1 is one step higher than the other areas of first surface A. However, reference surface Z1 and regions other than reference surface Z1 of first surface A are surfaces parallel to each other. In addition, reference surface Z1 and regions other than reference surface Z1 of first surface A are surfaces formed at the same time by forming surfaces orthogonal to the direction of movement of the movable die. As a result, reference surface Z1 and regions other than reference surface Z1 of first surface A are equivalent as reference surfaces for positioning with respect to the optical axis direction.

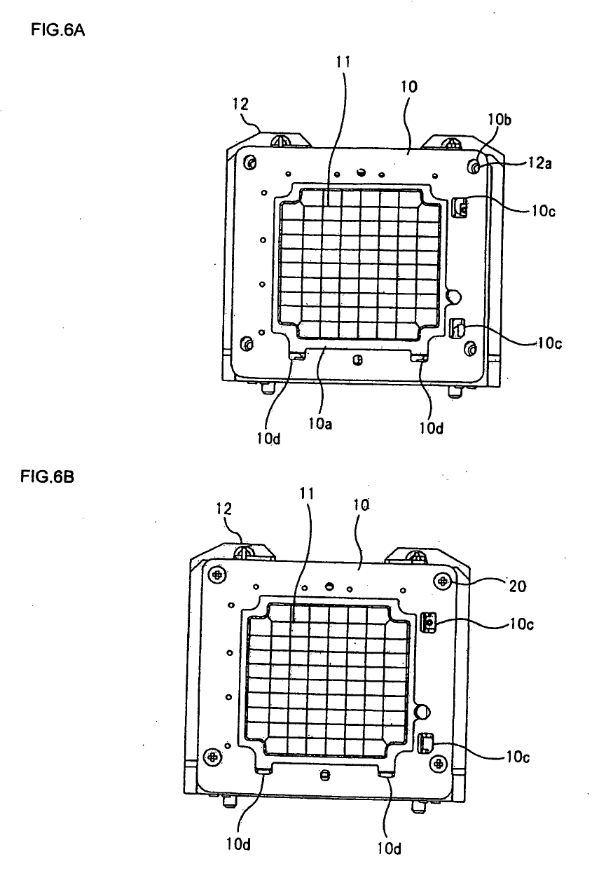

The two side surfaces 11b and 11c of first integrator lens 11 that are orthogonal to each other contact with reference surfaces X1 and Y1, respectively, of holder 12. As shown in FIG. 6, two openings (verification ports 10c) are provided in first frame-shaped metal plate 10 for checking the state of contact between side surface 11b of first integrator lens 11 and reference surfaces X1 of holder 12. In addition, two openings (cut-outs 10d) are provided in first frame-shaped metal plate 10 for checking the state of contact between side surface 11c of first integrator lens 11 and reference surfaces Y1 of holder 12.

First integrator lens 11 (first frame-shaped metal plate 10) is secured to holder 12 by the following procedure. As shown in FIG. 6A, the rear surface of first frame-shaped metal plate 10 is placed in contact with reference surface Z1 of holder 12 and the positioning of the optical axis direction of first integrator lens 11 carried out. Next, with the rear surface of first frame-shaped metal plate 10 and reference surface Z1 of holder 12 placed in contact, first frame-shaped metal plate 10 is moved in the horizontal direction and vertical direction to place side surface 11b of first integrator lens in contact with reference surfaces X1 and side surface 11c in contact with reference surfaces Y1. In other words, first frame-shaped metal plate 10 is slid across reference surface Z1 to place side surface 11b of first integrator lens 11 in contact with reference surfaces X1 and side surface 11c in contact with reference surfaces Y1. At this time, the state of contact of side surfaces 11b and 11c with reference surfaces X1 and Y1 can be checked from verification ports 10c and cutouts 10d. Then, as shown in FIG. 6B, screws 20 are inserted into each of holes 10b (FIG. 6A) of first frame-shaped metal plate 10 and inserted screws 20 then screwed into screw-holes 12a (FIG. 6A) of holder 12, whereby first integrator lens 11 is accurately positioned with respect to the three orthogonal axial directions (the X-axis, Y-axis, and Z-axis directions) and secured to holder 12.

As can be understood from the foregoing explanation, one characteristic of the present invention is the construction for positioning in the optical axis direction of first integrator lens 11. In other words, first surface A of holder 12 has higher accuracy than other surfaces and lens formation surface 11a of first integrator lens 11 has higher accuracy than the rear surface, as stated previously. Accordingly, if lens formation surface 11a of first integrator lens 11 is placed in contact with first surface A of holder 12 to carry out positioning, positioning accuracy with respect to the optical axis direction can be improved. However, first integrator lens 11 is arranged in a direction by which the rear surface confronts first surface A of holder 12. As a result, lens formation surface 11a of first integrator lens 11 cannot be placed in contact with first surface A. In response, in the present invention, first integrator lens 11 is positioned with respect to first frame-shaped metal plate 10 with lens formation surface 11a having high accuracy as the reference surface, and this first frame-shaped metal plate 10 is positioned with first surface A of holder 12 as a reference surface. As a result, the positioning accuracy of first integrator lens 11 in the optical axis direction can be improved.

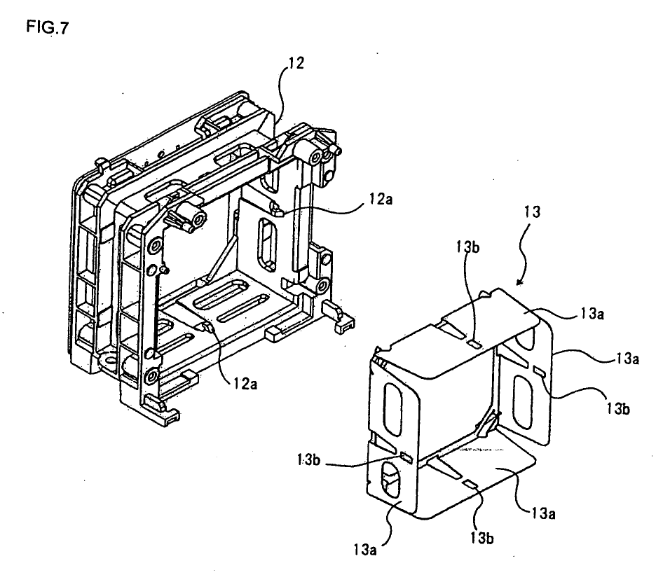

Light-shield part 13 and the construction for securing light-shield part 13 are next described with reference to FIG. 7. FIG. 7 is an exploded perspective view of optical unit 1 as seen from the light-emission side. However, a portion of the constituent elements has been omitted from the figure. Light-shield part 13 includes four side surface parts 13a bent at approximately 90° toward the light-emission side. This light-shield part 13 is arranged on the inner side of holder 12, and each side surface part 13a of light-shield part 13 covers a corresponding inner surface of holder 12. Still further, engagement holes 13b are provided in each side surface part 13a, and engagement projections 12a that are provided to protrude from each inner surface of holder 12 fit into these engagement holes 13b. When all or a portion of side surface parts 13a are caused to elastically deform inwardly, the engagement of engagement projections 12a and engagement holes 13b is released and light-shield part 13 can be withdrawn from holder 12.

The greater part of the inner surfaces of holder 12 is covered by side surface parts 13a of light-shield part 13. However, at least reference surfaces X1, X2, Y1, and Y2 are exposed without being covered by side surface parts 13a.

The construction for securing second integrator lens 14 to holder 12 is next described with reference to FIG. 8. The construction for securing second integrator lens 14 is substantially equivalent to the construction for securing first integrator lens 11. In other words, second integrator lens 14 is secured to second frame-shaped metal plate 15. More specifically, the lens group of second integrator lens 14 fits into opening 15a of second frame-shaped metal plate 15, and lens formation surface 14a on the periphery of the lens group is bonded to the rear surface of second frame-shaped metal plate 15. Second frame-shaped metal plate 15, to which second integrator lens 14, is secured is then secured to second surface B of holder 12 by means of screws 21 (FIG. 3).

In addition, screw-holes 12c into which screws 21 are screwed are formed in second surface B of holder 12. The outer periphery of the rear surface of second frame-shaped metal plate 15 directly contacts with the surfaces around screw-holes 12c. In other words, on second surface B of holder 12, the areas around screw-holes 12c are reference surface Z2 for positioning second frame-shaped metal plate 15 with respect to the optical axis direction. This means that second integrator lens 14 that is secured to second frame-shaped metal plate 15 is positioned with respect to the optical axis direction with reference surface Z2 as the reference. Referring to FIG. 8, reference surface Z2 is a step higher than the other areas of second surface B. However, reference surface Z2 and other areas of second surface B are mutually parallel surfaces. In addition, reference surface Z2 and other areas of second surface B are surfaces that are formed at the same time by forming surfaces orthogonal to the direction of movement of the movable die. As a result, reference surface Z2 and other areas of second surface B are equivalent as reference surfaces for positioning with respect to optical axis direction.

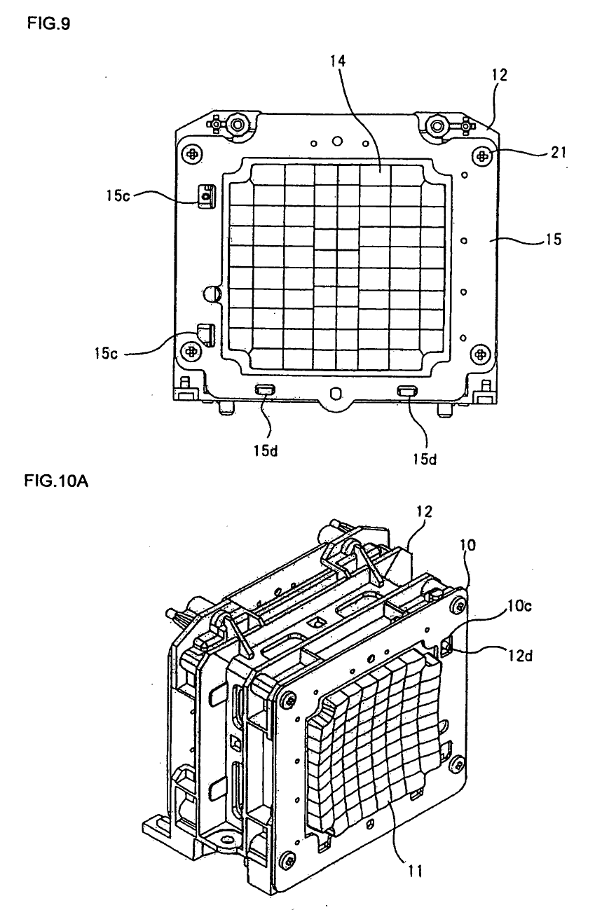

The procedure for securing second integrator lens 14 (second frame-shaped metal plate 15) to holder 12 is the same as the procedure for securing first integrator lens 11 (first frame-shaped metal plate 10) to holder 12. In other words, the rear surface of second frame-shaped metal plate 15 is placed in contact with reference surface Z2 of holder 12 to realize positioning with respect to the optical axis direction of second integrator lens 14. Next, with the rear surface of second frame-shaped metal plate 15 and reference surface Z2 of holder 12 placed in contact, second frame-shaped metal plate 15 is moved in the horizontal direction and in the vertical direction to place side surface 14b of second integrator lens 14 in contact with reference surfaces X2 and to place side surface 14c in contact with reference surfaces Y2. In other words, second frame-shaped metal plate 15 is slid over reference surface Z2 to place side surface 14b of second integrator lens 14 in contact with reference surfaces X2 and to place side surface 14c in contact with reference surfaces Y2. At this time, the state of contact between each of side surface 14b and reference surfaces X2 and side surface 14c and reference surfaces Y2 can be checked from openings (verification ports 15c and 15d) that are provided in second frame-shaped metal plate 15. Next, as shown in FIG. 9, screws 21 are inserted into each of holes 15b of second frame-shaped metal plate 15 and inserted screws 21 are then screwed into screw-holes 12c of holder 12 (FIG. 8). By the foregoing procedure, second integrator lens 14 is accurately positioned with respect to the orthogonal triaxial directions (X-axis, Y-axis, and Z-axis directions) and secured to holder 12.

As can be understood from the foregoing explanation, another characteristic of the present invention is the positioning construction in the optical axis direction of second integrator lens 14. In other words, second surface B of holder 12 has higher accuracy than other surfaces, and lens formation surface 14a of second integrator lens 14 has higher accuracy than the rear surface, as previously stated. Accordingly, if lens formation surface 14a of second integrator lens 14 is placed in contact with second surface B of holder 12 to realize positioning, the positioning accuracy with respect to the optical axis direction can be improved. However, second integrator lens 14 is arranged in a direction such that its rear surface confronts second surface B of holder 12. As a consequence, lens formation surface 14a of second integrator lens 14 cannot be placed in contact with second surface B. In response, in the present invention, second integrator lens 14 is positioned with respect to second frame-shaped metal plate 15 with lens formation surface 14a having high accuracy as the reference surface, and second frame-shaped metal plate 15 is positioned with second surface B of holder 12 as the reference surface. As a result, the positioning accuracy in the optical axis direction of second integrator lens 14 can be improved.

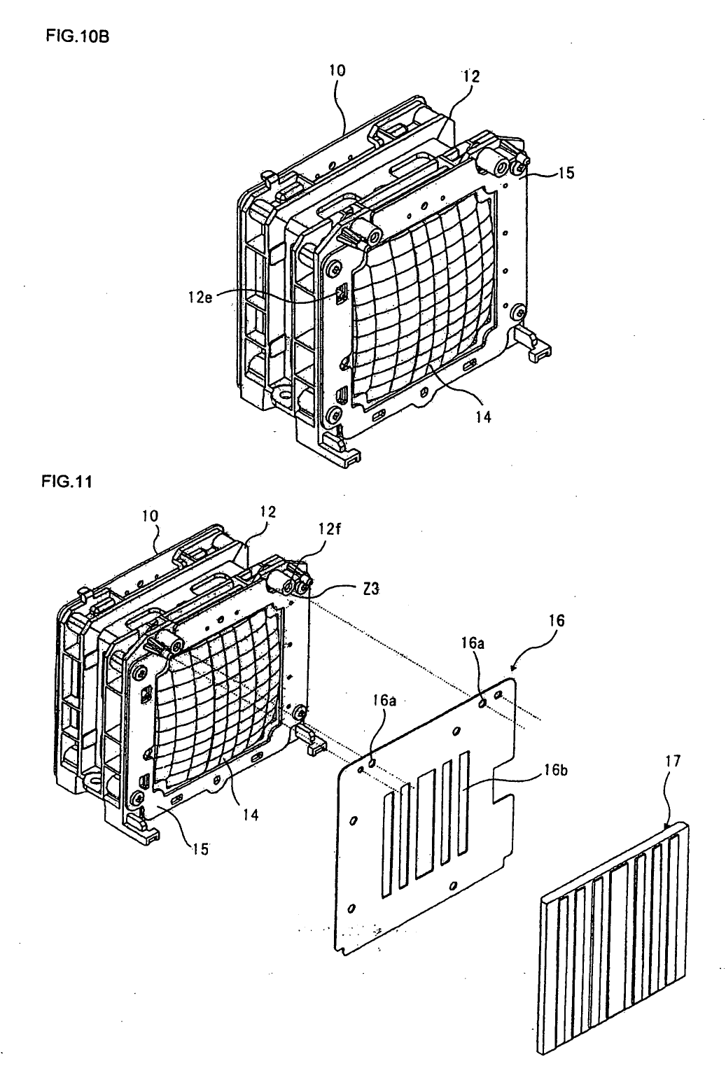

FIGS. 10A and 10B show holder 12 with first integrator lens 11 and second integrator lens 14 attached in this way. FIG. 10A is a perspective view of holder 12 as seen from the side of the first integrator lens. FIG. 10B is a perspective view of holder 12 as seen from the side of the second integrator lens. As shown in FIG. 10A, first pin 12d provided in first surface A of holder 12 protrudes from one of verification ports 10c of first frame-shaped metal plate 10. In addition, as shown in FIG. 10B, second pin 12e provided in second surface B of holder 12 protrudes from one of verification ports 15c of second frame-shaped metal plate 15. When these pins 12d and 12e protrude from a predetermined verification port, first integrator lens 11 and second integrator lens 14 are secured in holder in the correct orientation.

The construction for securing polarization conversion element 17 to holder 12 is next described with reference to FIG. 11. Polarization conversion element 17 is bonded to one of the principal surfaces of prepositioned light-shield plate 16. The light-incident surface of polarization conversion element 17 is bonded to the principal surface of light-shield plate 16. Light-shield plate 16 that is unified with polarization conversion element 17 is secured to holder 12. The principal surface (rear surface) of light-shield plate 16 that is opposite the principal surface to which polarization conversion element 17 is bonded contacts with second side surface B of holder 12. More specifically, screws 22 (FIG. 3) that are inserted into holes 16a provided in light-shield plate 16 are screwed into screw-holes 12f provided on second surface B of holder 12, and the rear surface of light-shield plate 16 thus directly contacts with the surfaces around screw-holes 12f. In other words, on second surface B of holder 12, the surfaces around screw-holes 12f are used as reference surface Z3 for positioning light-shield plate 16 with respect to the optical axis direction. This means that polarization conversion element 17 that is secured to light-shield plate 16 is positioned with respect to the optical axis direction with reference surface Z3 as the reference. Referring to FIG. 11, reference surface Z3 is a step higher than other areas of second surface B that include reference surface Z2. However, reference surface Z3 and other areas of second surface B are surfaces that are mutually parallel. In addition, reference surface Z3 and other areas of second surface B are surfaces formed at the same time by forming surfaces orthogonal to the direction of movement of the movable die. As a result, reference surface Z3 and other portions of second surface B are equivalent as reference surfaces for positioning with respect to the optical axis direction. In addition, reference surface Z3 is also equivalent to reference surface Z2.

Light-shield plate 16 is an aluminum plate having a thickness of 0.5 mm, and is provided with a plurality of slits 16b through which light, that is emitted from second integrator lens 14, is selectively transmitted.

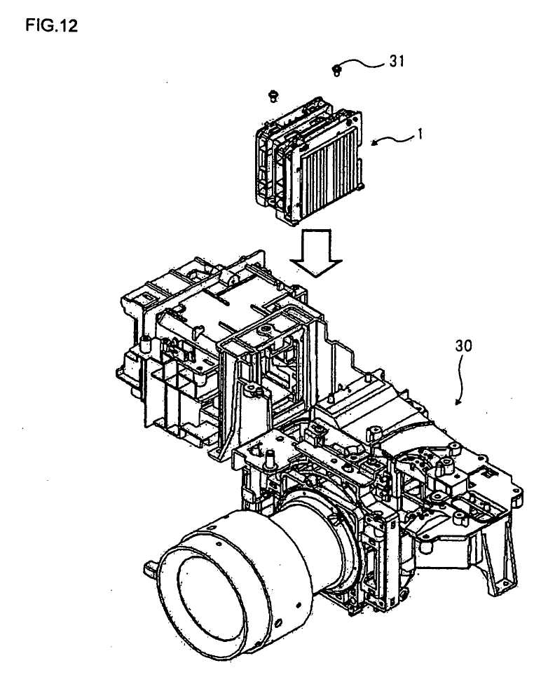

FIG. 12 is a perspective view showing the state when optical unit 1 according to the present embodiment is incorporated in optical engine 30 of a projection display device. Positioning pins 12g (FIG. 2) provided at the base of optical unit 1 (holder 12) fit into positioning holes (not shown) provided in the base of optical engine 30 and optical unit 1 is secured to optical engine 30 by screws 31.

In the present specification, an example was shown in which two lens arrays oriented with mutually confronting rear surfaces are secured to a holder. However, the two lens arrays may also be secured to the holder in an orientation in which the rear surface of one lens array confronts the lens formation surface of the other lens array. In this case, the lens formation surface can be used without alteration for positioning of the lens array that is arranged with the lens formation surface toward the holder side. As a result, when two lens arrays are secured to the holder in an orientation in which the rear surface of one lens array confronts the lens formation surface of the other lens array, it is sufficient to position only the lens array that is arranged with the rear surface directed toward the holder side in the holder with the frame-shaped metal plate interposed.

This application claims the priority based on JP-A-2007-264442 for which application was submitted on Oct. 10, 2007 and incorporates all of the disclosures of that application.

1. An optical unit provided with a first lens array and a second lens array secured to a holder, wherein light emitted from said first lens array passes through said holder and is incident to said second lens array; said optical unit comprising:
a first frame-shaped metal plate that is secured to said holder in a state in which a portion of the principal surface contacts with a first surface of said holder;
wherein said first lens array is positioned with respect to the optical axis direction by securing the lens formation surface to an area which is a part of said principal surface of said first frame-shaped metal plate and which does not contact with said first surface of said holder.

2. An optical unit provided with a first lens array and a second lens array secured to a holder, wherein light emitted from said first lens array passes through said holder and is incident to said second lens array, said optical unit comprising:
a first frame-shaped metal plate that is secured to said holder in a state in which a portion of the principal surface contacts with a first surface of said holder;
a second frame-shaped metal plate secured to said holder in a state wherein a portion of the principal surface contacts with a second surface that is the side opposite said first surface of said holder;
wherein said first lens array is positioned with respect to the optical axis direction by securing the lens formation surface to an area which is a part said principal surface of said first frame-shaped metal plate and which does not contact with said first surface of said holder, and
said second lens array is positioned with respect to said optical axis direction by securing the lens formation surface to an area which is a part said principal surfaces of said second frame-shaped metal plate and which does not contact with said second surface of said holder.

3. An optical unit provided with a first lens array and a second lens array secured to a holder, wherein light emitted from said first lens array passes through said holder and is incident to said second lens array, said optical unit comprising:
a first frame-shaped metal plate that is secured to said holder in a state in which a portion of the principal surface contacts with a first surface of said holder;
a second frame-shaped metal plate secured to said holder in a state wherein a portion of the principal surface contacts with a second surface that is the side opposite said first surface of said holder; and
first reference surfaces provided on said holder;
wherein said first lens array is positioned with respect to the optical axis direction by securing the lens formation surface to an area which is a part said principal surface of said first frame-shaped metal plate and which does not contact with said first surface of said holder, said second lens array is positioned with respect to said optical axis direction by securing the lens formation surface to an area which is apart said principal surfaces of said second frame-shaped metal plate and which does not contact with said second surface of said holder, and
said first reference surfaces are placed in contact with a first side surfaces of said first lens array and said second lens array to position said first lens array and said second lens array with respect to a second direction that is orthogonal to said optical axis direction.

4. An optical unit provided with a first lens array and a second lens array secured to a holder, wherein light emitted from said first lens array passes through said holder and is incident to said second lens array, said optical unit comprising:
a first frame-shaped metal plate that is secured to said holder in a state in which a portion of the principal surface contacts with a first surface of said holder;
a second frame-shaped metal plate secured to said holder in a state wherein a portion of the principal surface contacts with a second surface that is the side opposite said first surface of said holder; and
first reference surfaces and second reference surfaces provided on said holder;
wherein said first lens array is positioned with respect to the optical axis direction by securing the lens formation surface to an area which is a part of said principal surface of said first frame-shaped metal plate and which does not contact with said first surface of said holder,
said second lens array is positioned with respect to said optical axis direction by securing the lens formation surface to an area which is a part of said principal surfaces of said second frame-shaped metal plate and which does not contact with said second surface of said holder,
said first reference surfaces are placed in contact with first side surfaces of said first lens array and said second lens array to position said first lens array and said second lens array with respect to a second direction that is orthogonal to said optical axis direction, and
said second reference surfaces are placed in contact with second side surfaces of said first lens array and said second lens array to position said first lens array and said second lens array with respect to a third direction that is orthogonal to said optical axis direction and said second direction.

5. The optical unit as set forth in claim 4, wherein: first openings for exposing contact points of said first side surfaces of said first lens array and said second lens array and said first reference surfaces and second openings for exposing contact points of said second side surfaces of said first lens array and said second lens array and said second reference surfaces are provided in said first frame-shaped metal plate and said second frame-shaped metal plate.

6. The optical unit as set forth in claim 2, further comprising:
a light-shield plate for blocking a portion of light emitted from said second lens array; and
a polarization conversion element secured to said light-shield plate for converting the polarization direction of light that has passed through said light-shield plate;
wherein one principal surface of said light-shield plate contacts with an area which is a part of said second surface of said holder and which does not contact with said second frame-shaped metal plate; and
said polarization conversion element contacts with the other principal surface of said light-shield plate.

7. The optical unit as set forth in claim 3, further comprising:
a light-shield plate for blocking a portion of light emitted from said second lens array; and
a polarization conversion element secured to said light-shield plate for converting the polarization direction of light that has passed through said light-shield plate;
wherein one principal surface of said light-shield plate contacts with an area which is a part of said second surface of said holder and which does not contact with said second frame-shaped metal plate; and
said polarization conversion element contacts with the other principal surface of said light-shield plate.

8. The optical unit as set forth in claim 4, further comprising:
a light-shield plate for blocking a portion of light emitted from said second lens array; and
a polarization conversion element secured to said light-shield plate for converting the polarization direction of light that has passed through said light-shield plate;
wherein one principal surface of said light-shield plate contacts with an area which is a part of said second surface of said holder and which does not contact with said second frame-shaped metal plate; and
said polarization conversion element contacts with the other principal surface of said light-shield plate.

9. The optical unit as set forth in claim 2, wherein:
said holder is formed by injection molding using a die comprising a set of a fixed die and a movable die; and
said first surface and said second surface are formed by forming surfaces that are the forming surfaces of said fixed die and said movable die and that are orthogonal to the direction of movement of said movable die with respect to said fixed die.

10. The optical unit as set forth in claim 3, wherein:
said holder is formed by injection molding using a die including a pair of a fixed die and a movable die; and
said first surface and said second surface are formed by forming surfaces that are the forming surfaces of said fixed die and said movable die and that are orthogonal to the direction of movement of said movable die with respect to said fixed die.

11. The optical unit as set forth in claim 4, wherein:
said holder is formed by injection molding using a die including a pair of a fixed die and a movable die; and
aid first surface and said second surface are formed by forming surfaces that are the forming surfaces of said fixed die and said movable die and that are orthogonal to the direction of movement of said movable die with respect to said fixed die.

12. The optical unit as set forth in claim 1, further comprising a light-shield part arranged in said holder for preventing leakage of light that passes through said holder, wherein said light-shield part contacts with the inner surface of said holder by an elastic restoring force.

13. The optical unit as set forth in claim 2, further comprising a light-shield part arranged in said holder for preventing leakage of light that passes through said holder, wherein said light-shield part contacts with the inner surface of said holder by an elastic restoring force.

14. The optical unit as set forth in claim 3, further comprising a light-shield part arranged in said holder for preventing leakage of light that passes through said holder, wherein said light-shield part contacts with the inner surface of said holder by an elastic restoring force.

15. The optical unit as set forth in claim 4, further comprising a light-shield part arranged in said holder for preventing leakage of light that passes through said holder, wherein said light-shield part contacts with the inner surface of said holder by an elastic restoring force.

16. The optical unit as set forth in claim 12, wherein engagement projections provided on said inner surfaces of said holder fit into engagement holes provided in said light-shield part, and fitting of said engagement projections with said engagement holes is released when said light-shield part is elastically deformed.

17. A projection display device that includes an illumination optical system that includes the optical unit as set forth in claim 1.

18. A projection display device that includes an illumination optical system that includes the optical unit as set forth in claim 2.

19. A projection display device that includes an illumination optical system that includes the optical unit as set forth in claim 3.

20. A projection display device that includes an illumination optical system that includes the optical unit as set forth in claim 4.
